(19) United States
(12) Patent Application Publication
(10) Pub. No.: US 2002/0082059 A1
(43) Pub. Date: Jun. 27, 2002

(54) Portable mobile unit

(75) Inventors: Koichiro Nariai, Hitachinaka (JP); Hiroshi Hashizume, Hitachinaka (JP); Toshihiko Shiobara, Hitachinaka (JP); Ryota Mita, Hitachinaka (JP)

Correspondence Address: McDermott, Will & Emery, 600 13th Street, N.W., Washington, DC, 20005-3096, US

(73) Assignee: Hitachi, Ltd.

(21) Appl. No.: 09/984,769

(22) Filed: Oct. 31, 2001

(30) Foreign Application Priority Data
Dec. 25, 2000 (JP) 2000-391796

(51) Int. Cl. H04M 1/00

(52) U.S. Cl. 455/573; 455/572

(57) ABSTRACT

Conventional portable mobile units have a problem that the user cannot enjoy a built-in music reproduction function at a start of charging a battery. Further, no consideration is given to the control of the music reproduction function to be performed when the remaining power of the battery is small. According to the invention, a portable mobile unit capable of reproducing data (musical data etc.) stored therein is provided with a charge detector for detecting a charging condition of a battery or a remaining power detector for detecting remaining power of a battery. The start of data reproduction is enabled when a start of battery charging is detected, or it is prohibited when remaining power of the battery is smaller than a preset value. This enables not only notification using music selected by the user at the time of charging but also power saving when the remaining power of the battery is small.

### BACKGROUND OF THE INVENTION

1. Field of the Invention

The present invention relates to a portable mobile unit capable of reproducing a plurality of data stored therein such as musical data. In particular, the invention relates to a portable mobile unit that can improve ease of use during charging and increase the speech time.

2. Description of the Related Art

In an ordinary state, a portable mobile unit operates using a battery as a power source. Therefore, after a portable mobile unit has been used for a certain period, the amount of energy stored in the battery becomes small and charging of the battery becomes necessary. Conventional portable mobile units visually announce ongoing, completion, etc. of charging by means of a message on a display or a light-emitting device (e.g., an LED). Functions that operate with detection of charging of a battery include a function of switching the call arrival announcing method from one using sound to one using vibration and a function of controlling an auto power on/off function capable of turning on or off the power of a portable mobile unit after a lapse of a predetermined time. In this manner, no limitation is imposed on added functions during charging because it is not necessary to take power saving into consideration during charging. Japanese Unexamined Patent Publication No. Hei. 11-68648 relates this conventional technique. In this publication, a charging connection detecting means for detecting a connection state between a power source and a charging circuit for a battery (rechargeable battery). With a detection result used as a parameter, control can be performed so that the call arrival announcing method is switched from one using vibration of a vibrator to one using sound output of a sounder, an auto power on/off function of on/off-controlling the supply of power to individual circuits of a portable mobile unit is switched from on to off, or a phone-answering function is switched.

Portable mobile units of such types that a memory for reproduction of music is provided and plural pieces of favorite music that are stored in the memory can be reproduced at a desired time for the user's enjoyment or can be reproduced as sound for announcing call arrival are now spreading. That is, attempts are being made to allow the user to enjoy his favorite music.

On the other hand, there is a technique that, to secure a sufficient speech time, restricts (including stopping) operation of function blocks that are irrelevant to communication when the remaining power of a battery has become small. Examples of the function blocks irrelevant to communication are an illumination device such as a screen illumination, a display, and a musical information storage block for reproduction of music (added function). Among those techniques is a technique of restricting basic functions of a portable mobile unit (Japanese Unexamined Patent Publication No. 2000-253142). In this technique, the power consumption can be controlled on a function block basis. When the remaining power of a battery has become small during a call, the power consumption is reduced by restricting (including stopping) operation of an illumination device such as a screen illumination, a display, and even a transmitting section (during reception).

Japanese Unexamined Patent Publication No. 2000-308269 discloses a technique of restricting added functions. In this technique, in a portable mobile unit having a musical information storage section for reproduction of music using an external storage medium such as a magnetic disk, operation of the block of the musical information storage section is stopped when the remaining power of a battery has become small and the power consumption is thereby reduced.

However, the above-described techniques have the following problems.

First, the conventional notification relating to, for example, a start or completion of charging is performed visually by means of a message on a display, a light-emitting device, or the like. Therefore, the user cannot be notified unless the portable mobile unit is located at such a position as to be seen by the user.

Second, since the music reproduction function as a built-in function is not activated automatically when charging of a battery is started, the user cannot be notified by means of his favorite music.

Third, although it has already been done to stop operation of a function when the remaining power of a battery is small, no technique is available that prohibits activation of a function even when the user has made a manipulation for activating the function.

Fourth, although the music reproduction function using a built-in memory does not exist as a function block, music is output from a speaker or the like and power is consumed if it is activated. No consideration is given to increase of the speech-possible time in the form of restriction to an item that does not exist as a function block.

### SUMMARY OF THE INVENTION

An object of the present invention is to provide a portable mobile unit that is easy to use and can increase the speech time.

A first aspect of the invention provides a portable mobile unit comprising a memory for storing data; a controller for controlling reproduction of the stored data; and a charge detector for detecting a charging state of a battery, wherein the controller starts reproduction of the data when the charge detector detects that charging of the battery has started.

In a first preferred embodiment, the controller performs control so that the reproduction of the data is stopped after a lapse of an arbitrary preset time from the start of the reproduction of the data.

In a second preferred embodiment, the controller performs control so that the reproduction of the data is stopped when the charge detector detects suspension of the charging of the battery after the start of the reproduction of the data.

In a third preferred embodiment, the charge detector is so configured as to recognize whether the cause of suspension of the charging of the battery is a completion of the charging or an interruption of the charging by a user and as to be able to produce different outputs for the respective cases.

In a fourth preferred embodiment, the controller performs control so that notification is made before the reproduction of the data is stopped when the charge detector detects the suspension of the charging of the battery.

A second aspect of the invention provides a portable mobile unit comprising a memory for storing data; a controller for controlling reproduction of the stored data; and a remaining power detector for detecting remaining power of a battery, wherein the controller prohibits a start of reproduction of the data when the remaining power detector detects that the remaining power of the battery is smaller than a preset value.

In a first preferred embodiment, the controller cancels the prohibition of reproduction of the data when a user makes a predetermined manipulation even if the remaining power of the battery is smaller than the preset value.

In a second preferred embodiment, the controller performs control so that reproduction of the data is stopped after a lapse of an arbitrary preset time from a start of the reproduction of the data.

In a third preferred embodiment, the controller performs control so that an alarm is generated before the reproduction of the data is stopped.

The invention as described above can provide a portable mobile unit that is easy to use and can increase the speech time.

### BRIEF DESCRIPTION OF THE DRAWINGS

FIG. 1 is a front view showing the appearance of a portable mobile unit according to each of first to third embodiments of the present invention;

FIG. 2 is a block diagram showing the configuration of a portable mobile unit according to the first embodiment of the invention;

FIG. 3 is a flowchart showing a process to a start of automatic reproduction in the portable mobile unit according to the first embodiment;

FIG. 4 is a flowchart showing a process to be executed after the start of the automatic reproduction in the portable mobile unit according to the first embodiment;

FIG. 5 is a flowchart showing another process to be executed after the start of the automatic reproduction in the portable mobile unit according to the first embodiment;

FIG. 6 is a flowchart showing a further process to be executed after the start of the automatic reproduction in the portable mobile unit according to the first embodiment;

FIG. 7 shows display pictures, that is, a standby display picture (part (a)), a function selection menu picture (part (b)), and an automatic reproduction mode setting picture (part (c)), in the portable mobile unit according to the first embodiment;

FIGS. 8A-8C show alarm notification pictures, that is, a display picture announcing that a reproduction time has elapsed, a display picture announcing that charging has been suspended, and a display picture announcing that charging has completed, respectively, in the portable mobile unit according to the first embodiment;

FIG. 9 shows display pictures, that is, an automatic reproduction mode setting picture (part (a); the same as the display picture of part (c) of FIG. 7), are production time setting picture (part (b)), and a setting completion display picture (part (c)), in the portable mobile unit according to the first embodiment;

FIG. 10 is a block diagram showing the configuration of a portable mobile unit according to the second embodiment of the invention;

FIG. 11 is a flowchart showing a process to a start of automatic reproduction in the portable mobile unit according to the second embodiment;

FIG. 12 is a flowchart showing another process to a start of automatic reproduction in the portable mobile unit according to the second embodiment;

FIG. 13 is a flowchart showing a process that is executed after a start of automatic reproduction in the portable mobile unit according to the second embodiment;

FIG. 14 shows alarm notification pictures, that is, a display picture asking whether to start automatic reproduction (part (a)), a display picture announcing a start of automatic reproduction (part (b)), a display picture announcing a stop of automatic reproduction (part (c)), and a display picture announcing that automatic reproduction will not be performed (part (d)), in the portable mobile unit according to the second embodiment; and

FIG. 15 is a block diagram showing the configuration of a portable mobile unit according to a third embodiment of the invention.

### DETAILED DESCRIPTION OF THE PREFERRED EMBODIMENTS

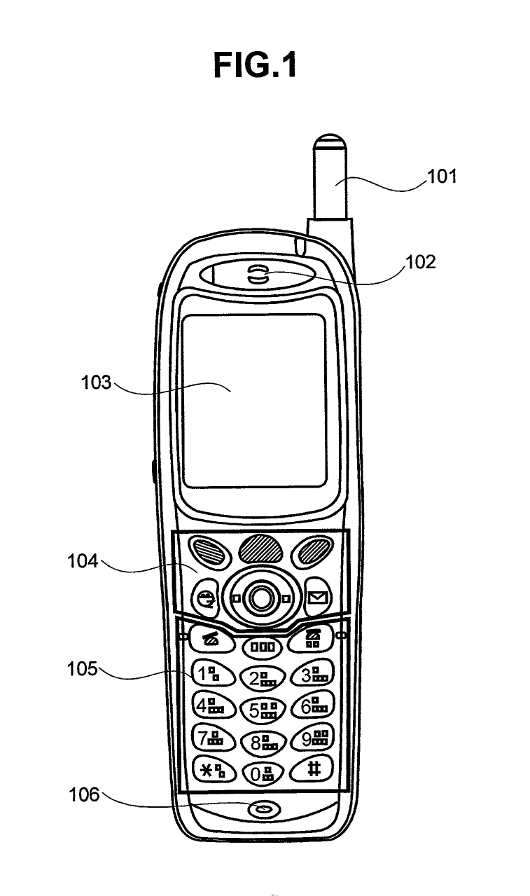

Embodiments of the present invention will be hereinafter described in detail with reference to the accompanying drawings. Each embodiment will be directed to a cellular phone as a portable mobile unit. In FIGS. 1-15, the same or equivalent components or steps are denoted by the same reference symbols. FIG. 1 is a front view showing the appearance of a portable mobile unit. Reference numeral 101 denotes a transmission/reception antenna; 102, a receiver, and 103, a display for displaying various kinds of information; 104, shift/decision keys to be used in setting a function; 105, input keys (including numeral keys) to be used in specifying a telephone number or specifying a number during a function search; and 106, a microphone. The appearance and the components shown in FIG. 1 are common to the following embodiments.

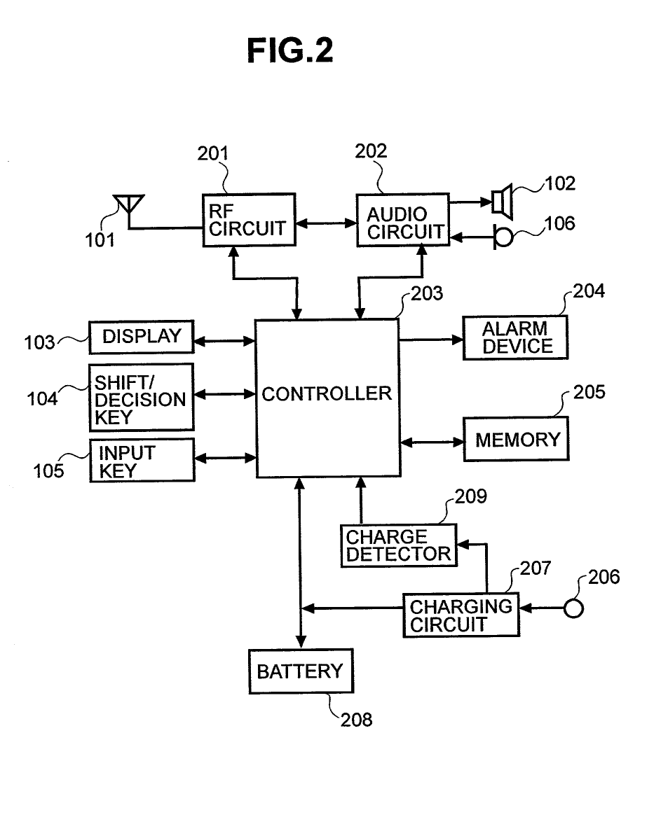

A portable mobile unit according to a first embodiment of the invention will be described below with reference to FIGS. 1-9. This portable mobile unit can reproduce a plurality of data (musical data etc.) stored therein. Further, provided with a charge condition detector (hereinafter referred to as “charge detector”) for detecting a condition of a battery being charged, the portable mobile unit can announce, by means of music selected by the user, that charging is being performed by starting reproduction of data when a start of the charging is detected by the charge detector. FIG. 2 is a block diagram showing the configuration of the portable mobile unit according to the first embodiment. Reference numeral 201 denotes a radio frequency circuit (hereinafter referred to as “RF circuit”) having a transmission/reception function; 202, an audio circuit; 203, a controller for controlling the entire portable mobile unit; 204, an alarm device for alarming the user by sound or vibration; 205, a memory for storing programs necessary for operation of cellular phone functions, setting data, and data of musical information to be used for reproducing music; 208, a battery (rechargeable battery); 206, an external power input terminal to be used for charging the battery 208; and 207, a charging circuit for charging the battery 208. Reference numeral 209 denotes a charge detector for detecting a charging state of the battery 208.

The operation of the portable mobile unit of FIG. 2 will be described below. During reception, an input signal received by the antenna 101 is decoded by the RF circuit 201 and the audio circuit 202 into voice, which is output to the receiver 102. During transmission, voice that is input through the microphone 106 is modulated by the audio circuit 202 and the RF circuit 201 into a transmission signal, which is transmitted from the antenna 101. In the above operations, the RF circuit 201 and the audio circuit 202 are controlled by the controller 203.

Next, a function of reproducing a plurality of stored data (musical data etc.) will be described. Examples of the data (musical data etc.) are sound data, text data, figure data, and video data. Examples of sound data are music, natural sound (e.g., sound of a water flow, a song of a bird, chirping of insects and a cry of an animal such as meow, bow-wow, moo, etc.), and artificial sound (e.g., a ring of a bell or a chime and a beep. The information of the plurality of data (musical data etc.) are stored in the memory 205. When the function of reproducing the plurality of data (musical data etc.) is started by either predetermined manipulations of the user on the input keys 105 and the shift/decision keys 104 or a transition of the portable mobile unit to a predetermined state, the plurality of data (musical data etc.) stored in the memory 205 are accessed sequentially by the controller 203 and reproduced as sound. As for the route of acquiring information of the above kind, data is prepared and stored in the portable mobile unit in advance, downloaded from an external system, or acquired in other ways.

When the portable mobile unit is set so as to start reproducing a plurality of data stored (such as musical data) at the time of starting battery charging, as a predetermined state, the controller 203 inquires of the charge detector 209 whether charging has been started and starts reproduction of the data (musical data etc.) by the above method upon detection of a start of charging.

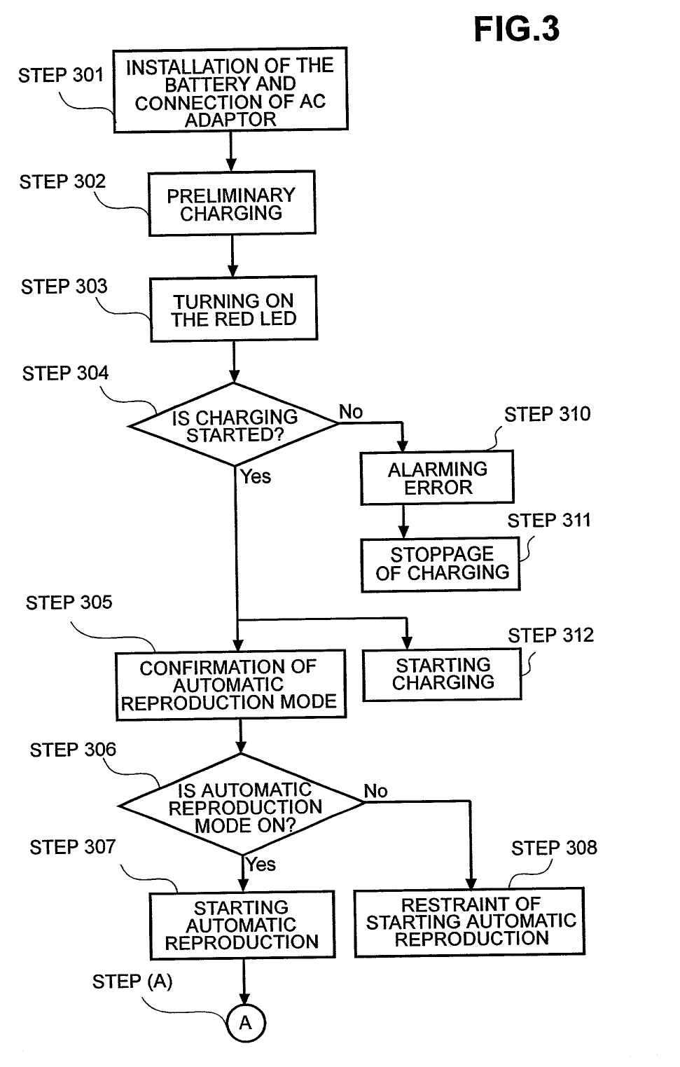

FIG. 3 is a flowchart showing a process according to this embodiment. When a battery 208 is mounted in the portable mobile unit capable of reproducing a plurality of data stored therein and an AC adapter is connected to it at step 301 to charge the battery 208, preliminary charging is performed at step 302 and a red LED is turned on at step 303. To confirm that charging has started, at step 304 the controller 203 inquires of the charge detector 209 whether charging has started. If charging is going on (yes), the process goes to step 305 (start of confirmation of an automatic reproduction mode) and main charging is started at step 312. A method for setting the automatic reproduction mode will be described later. If charging has not started (no), the process goes to step 310, where occurrence of an error is announced. At step 311, the charging operation is stopped.

When the process goes to step 305 (start of confirmation of an automatic reproduction mode), at step 306 the controller 203 inquires of the memory 205 whether the automatic reproduction mode is set. If the automatic reproduction mode is set (yes), the automatic reproduction mode is started at step 307, whereby step (A) is established in which musical information stored in the memory 205 is reproduced and output as sound from the receiver 102 and/or the alarm means 204. If the automatic reproduction mode is not set (no), the start of the automatic reproduction mode is prohibited at step 308. This is done by refraining from activating a program for the automatic reproduction function.

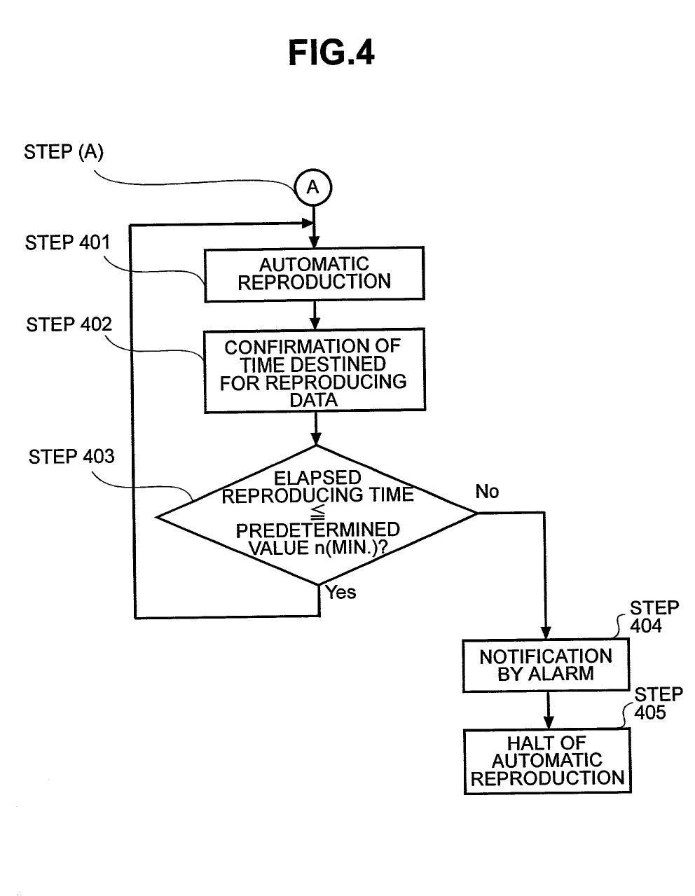

The portable mobile unit may be configured in such a manner that the reproduction time of data (musical data) is set at an arbitrary time. FIG. 4 is a flowchart showing a process corresponding to this case. FIG. 8A shows a display example of alarm notification corresponding to this case. When automatic reproduction is started at step 307 in FIG. 3 and step (A) is established, the automatic reproduction is continued at step 401. The process goes to step 402 (start of a check of a reproduction time), and at step 403 the controller 203 judges whether the reproduction time has reached an arbitrary preset time (n minutes). Monitoring the reproduction time, the controller 203 compares the reproduction time with the arbitrary time (n minutes) that is preset in the memory 205. If the reproduction time has reached the arbitrary preset time (no), alarm notification is performed at step 404 by displaying a picture as shown in FIG. 8A on the display 103 and the automatic reproduction is stopped at step 405. On the other hand, if the reproduction time has not reached the arbitrary preset time yet (yes), the process returns to step 401, where the automatic reproduction is continued. Since the user can set the reproduction time arbitrarily, selection can be made between an operation that data is reproduced for about one minute at the start of charging for only the notification purpose and an operation that data is reproduced for a desired time to allow the user to enjoy music. The device for performing the alarm notification is not limited to the display 103 and may be performed by at least one of the display 103, the receiver 102, and the alarm device 204. In the above process, the alarm notification is performed after the execution of step 403 before the stop of the automatic reproduction. Alternatively, the automatic reproduction may be stopped without performing the alarm notification.

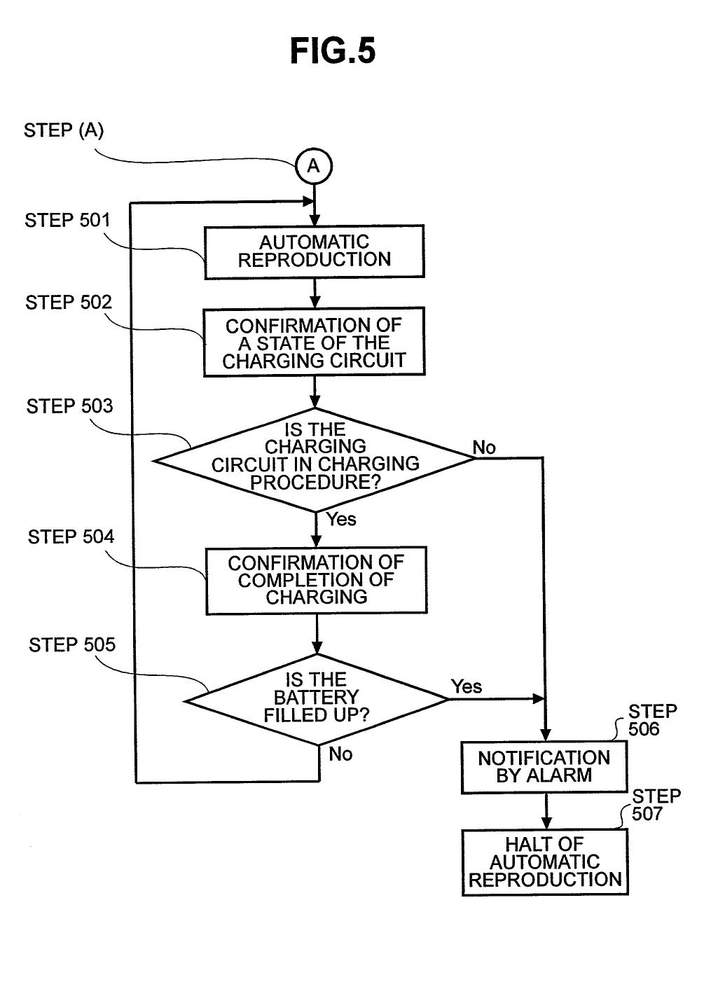

As a further alternative, reproduction of data (music) may be stopped when the charge detector 209 detects that charging of the battery has been suspended after the data reproduction has started upon detection of a start of the charging by the charge detector 209. FIG. 5 is a flowchart showing a process corresponding to this case. FIGS. 8B and 8C show display examples of alarm notification corresponding to this case. When automatic reproduction is started at step 307 in FIG. 3 and step (A) is established, the automatic reproduction is continued at step 501. Then, the process goes to step 502 (start of confirmation of charging). At step 503, to confirm that the charging is being continued, the controller 203 inquires of the charge detector 209 whether the charging is being continued. If the charging is being continued (yes), the process goes to step 504 (start of a check as to whether the charging has completed). If it is judged at step 503 that the charging is not being performed (no), alarm notification is performed at step 506 by displaying a picture as shown in FIG. 8B on the display 103 and the automatic reproduction is stopped at step 507.

After step 504 (start of a check as to whether the charging has completed), at step 505 the controller 503 inquires of the charge detector 209 whether the battery 208 has been charged up. If the battery 208 has been charged up (yes), alarm notification is performed at step 506 by displaying a picture as shown in FIG. 8C on the display 103 and the automatic reproduction is stopped at step 507. At this time, an alarm sound may be generated before stopping the reproduction of data (music). For example, a peep as an alarm sound may be generated several seconds before stopping the reproduction of data (music). This allows the user to know in advance an approaching stop of reproduction of data (music) at the time of a completion or suspension of charging. If it is judged at step 505 that the battery 208 has not been charged up yet (no), the process returns to step 501, where the automatic reproduction is continued.

With the above process, data (music) can be stopped automatically when charging of the battery 208 has been completed or suspended. The portable mobile unit may be configured in such a manner that when charging of the battery 208 has been stopped, the charge detector 209 recognizes whether the charging has been stopped due to charging-up of the battery 208 or the user's interruptive manipulation and the notification method is changed depending on the cause. For example, after the judgment at step 505, a second notification sound may be output from the alarm device 204 as the alarm notification at step 506. If charging is stopped though it is judged at step 505 that the battery 208 has not been charged up yet, a judgment can be made that the charging has been stopped due to the user's interruptive manipulation. Recognizing the reason of a stop of charging makes it possible to change the content of notification. For example, in the case of a stop of charging due to the user's interruptive manipulation, notification may be made by the second notification sound, that is, a notification sound that is different from an ordinary notification sound. This enables discrimination from a reproduction sound of data (music) that is generated at the time of completion of charging, that is, discrimination between completion and suspension of charging.

The device for performing the alarm notification is not limited to the display 103 and may be performed by at least one of the display 103, the receiver 102, and the alarm device 204. In the above process, the alarm notification is performed after the judgment at step 503 or 505 before the stop of the automatic reproduction. Alternatively, the automatic reproduction may be stopped without performing the alarm notification.

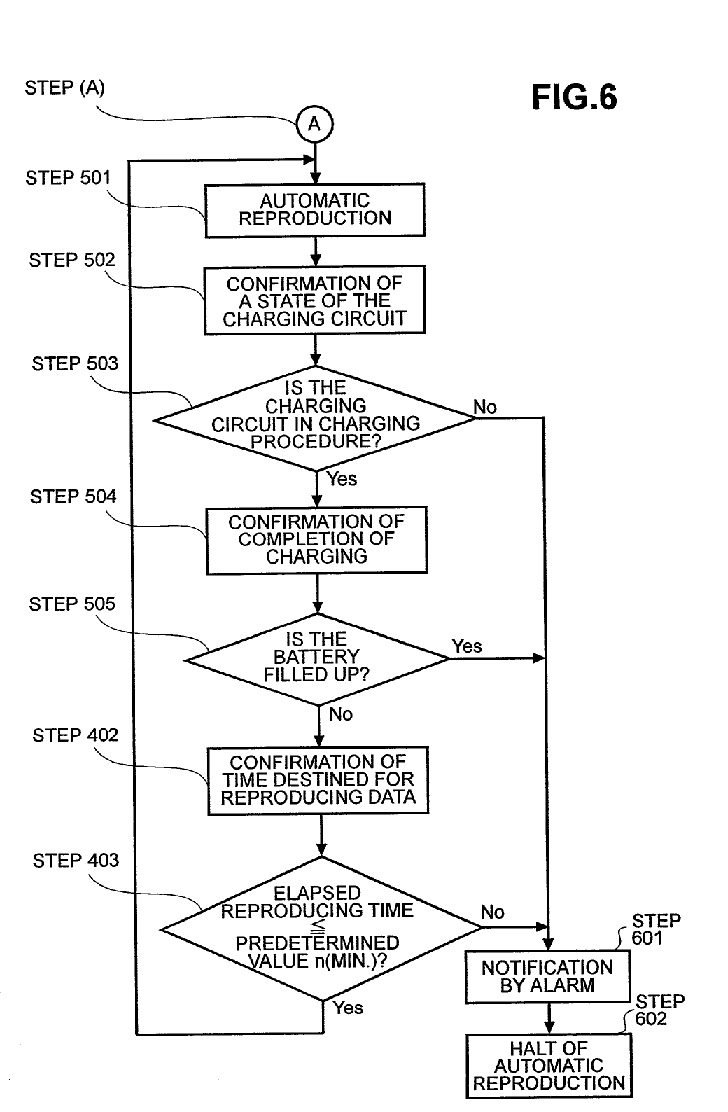

As shown in FIG. 6, the process that is executed after step (A) in FIG. 3 may be a combination of the processes of FIGS. 4 and 5. The process of FIG. 6 will be described below. Steps (A) to step 505 (inquiry about whether the battery 208 has been charged up) are the same as shown in FIG. 5, steps 402 and 403 are the same as shown in FIG. 4, and the alarm notification step is the same as shown in FIG. 4 and 5. Therefore, those steps will not be described here again. If it is judged at step 505 that the battery 208 has not been charged up yet (no), the process goes to step 402 (start of a check of reproduction time). If the battery 208 has been charged up (yes), alarm notification is performed at step 601 and the automatic reproduction is stopped at step 602.

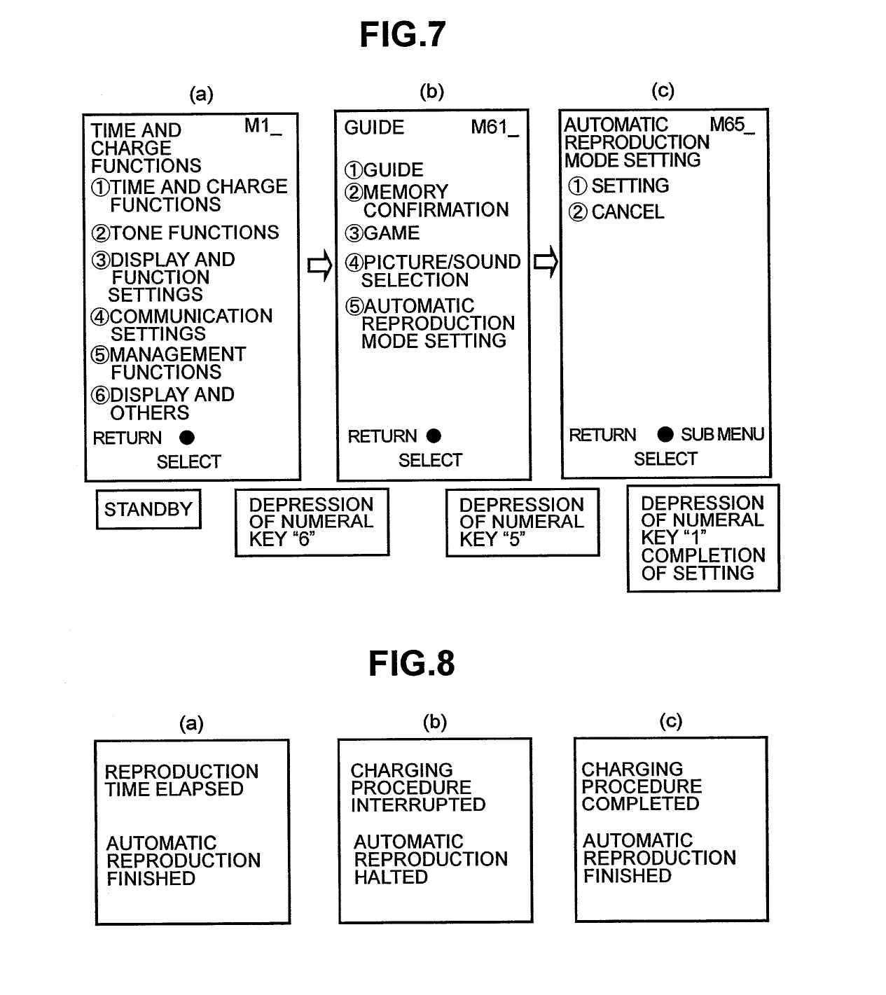

The portable mobile unit may be configured in such a manner that the data reproduction start function can be set and cancelled selectively by the user so that the user cancel the data reproduction start function at the time of detection of a start of charging of the battery 208 if the user does not want reproduction of data. Setting should be so made as to allow the user to set or cancel the data reproduction start function on a menu picture. FIG. 7 shows exemplary display pictures. A method for setting the automatic reproduction mode according to pictures displayed on the display 103 will be described with reference to FIG. 7. In a reception standby state, the picture of part (a) of FIG. 7 is displayed. Automatic reproduction mode setting is included in the functions of the item “6: Display and function settings.” If the numeral key “6” of the input keys 105 is depressed, the picture of part (b) of FIG. 7 appears. The automatic reproduction mode setting corresponds to the item “5: Automatic reproduction mode setting” in the picture of part (b) of FIG. 7. If the numeral key “5” of the input keys 105 is depressed, the picture of part (c) of FIG. 7 appears. Setting corresponds to the item “1: Setting” in the picture of part (c) of FIG. 7. If the numeral key “1” of the input keys 105 is depressed, the automatic reproduction setting is completed. The information of the automatic reproduction mode is stored in the memory 205.

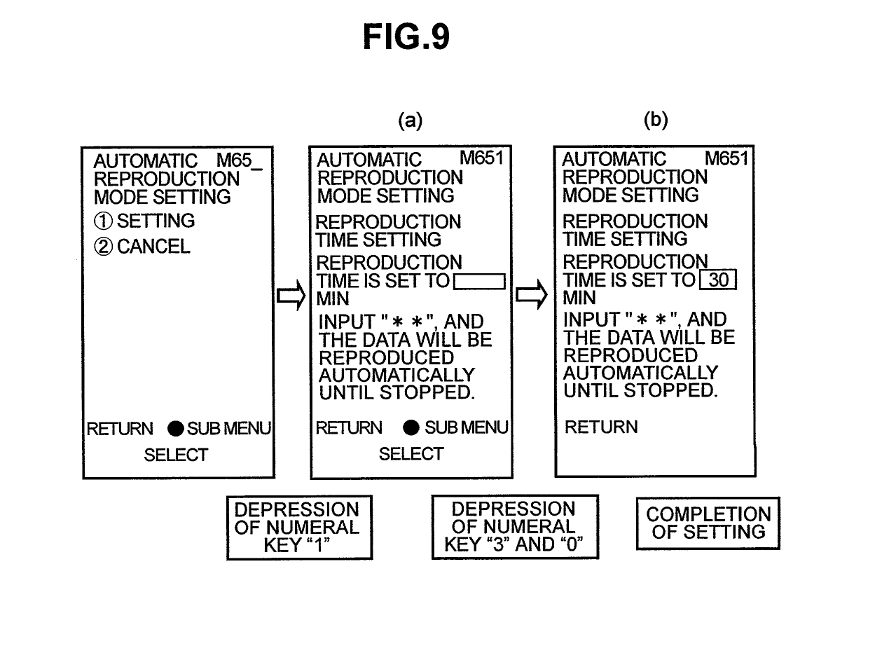

A reproduction time is set according to display pictures shown in parts (b) and (c) of FIG. 9. To set a reproduction time, first the manipulations for the automatic reproduction mode setting that have been described above with reference to FIG. 7 are performed. Whereas the automatic reproduction mode setting is completed upon depressing the numeral key “1” of the input keys 105 while the picture of part (c) of FIG. 7 is displayed, in the case where a reproduction time can be set the picture of part (b) of FIG. 9 appears upon depressing the numeral key “1” of the input keys 105 while the picture of part (c) of FIG. 7 is displayed. If the user wants to set the reproduction time at 30 minutes, for example, he inputs 30 minutes by depressing the numeral keys “3” and “0” of the input keys 105, whereupon the display picture of part (c) of FIG. 9 appears. The setting is completed when the user depresses the decision key of the shift/decision keys 104. This information is stored in the memory 205.

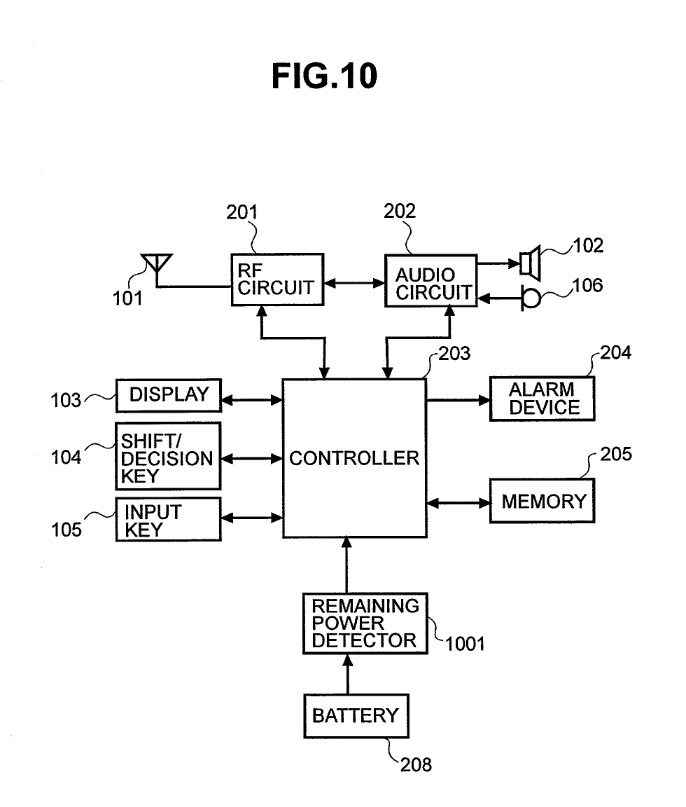

A portable mobile unit according to a second embodiment of the invention will be described below with reference to FIGS. 10-14. This portable mobile unit can reproduce a plurality of data (musical data etc.) stored therein. Further, provided with a remaining power detector for detecting remaining power of a battery, the portable mobile unit refrains from starting to reproduce the data (musical data etc.) if the remaining power of the battery is smaller than a preset value even when the user has made a manipulation for starting reproduction of the data, and thereby prevents power consumption that would otherwise be caused by reproduction of the data (musical data etc.). FIG. 10 is a block diagram showing the configuration of the portable mobile unit according to the second embodiment. Reference numeral 201 denotes an RF circuit having a transmission/reception function; 202, an audio circuit; 203, a controller for controlling the entire portable mobile unit; 204, an alarm device for alarming the user by sound or vibration; 205, a memory for storing programs necessary for operation of cellular phone functions, setting data, and musical information to be used for reproducing music; and 208, a battery (rechargeable battery). Reference numeral 1001 denotes a remaining power detector for detecting remaining power of the battery 208.

The basic operation of the function of reproducing the plurality of stored data (musical data etc.) is the same as described above with reference to FIG. 2 and hence will not be described. When the user tries to activate the function of reproducing the plurality of stored data (musical data etc.) at the time of a start of charging by performing predetermined manipulations on the input keys 105 and the shift/decision keys 104, the controller 203 inquires, of the remaining power detector 1001, remaining power of the battery 208 and judges whether the remaining power of the battery 208 is greater than or equal to a threshold value that is large enough to secure a predetermined speech time. If the remaining power of the battery 208 is greater than or equal to the threshold value, the controller 203 activates the function of reproducing the data (musical data etc.) If the remaining power of the battery 208 is smaller than the threshold value, the controller 203 prohibits activation of this function.

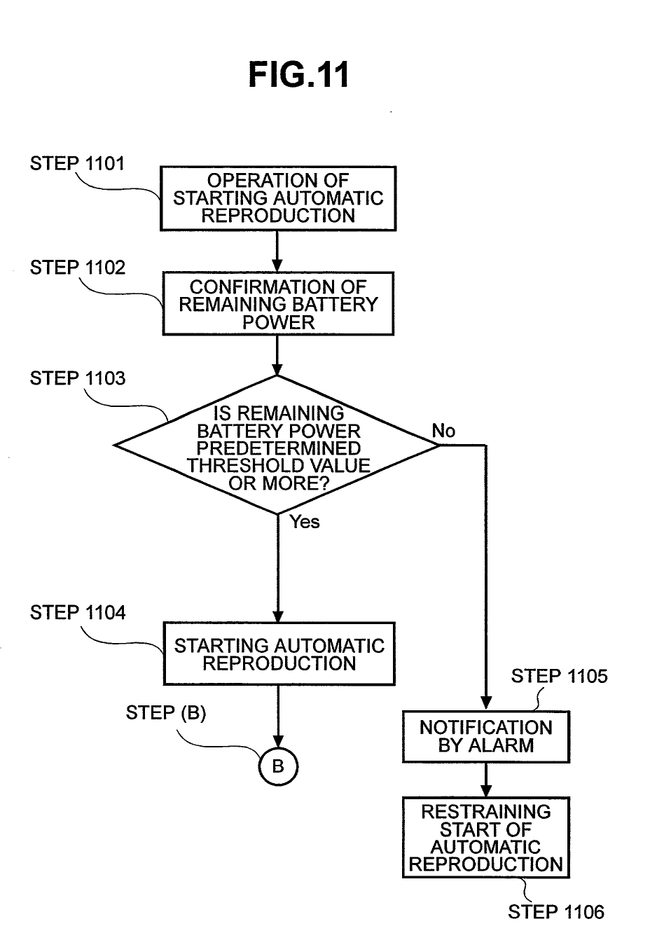

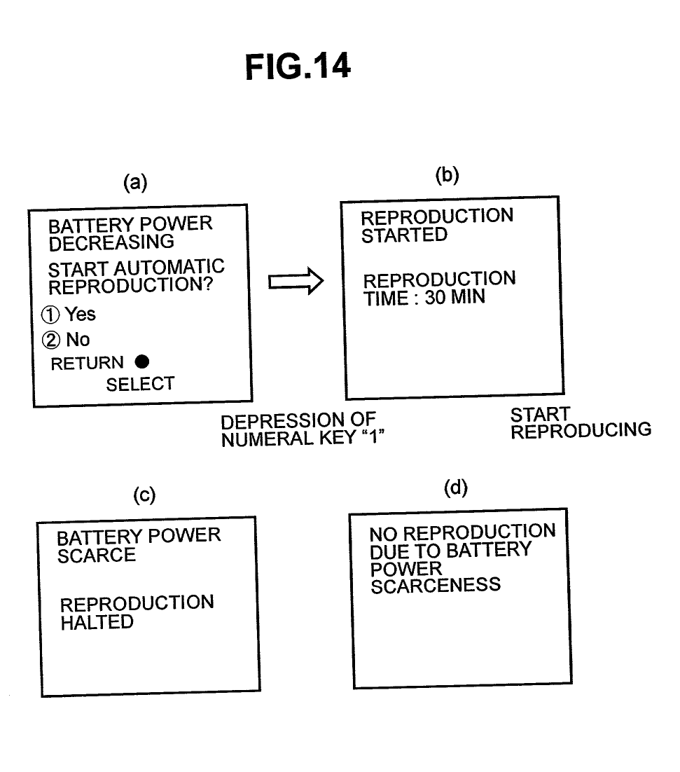

FIG. 11 is a flowchart showing a process according to this embodiment. Part (d) of FIG. 14 shows a display example of alarm notification. These process and display example will be described below. When manipulations for starting automatic reproduction are performed at step 1101 in the portable mobile unit capable of reproducing a plurality of data (musical data etc.) stored therein, the process goes to step 1102 (start of a check of remaining battery energy). To check remaining power of the battery 208, at step 1103 the controller 203 inquires, of the remaining power detector 1001, remaining power of the battery 208 and judges whether the remaining power of the battery 208 is greater than or equal to a threshold value that is large enough to secure a predetermined speech time. If the remaining power of the battery 208 is greater than or equal to the threshold value (yes), the process goes to step 1104, where automatic reproduction is started. As a result, step (B) is established in which musical information stored in the memory 205 is reproduced and output as sound from the receiver 102 and/or the alarm means 204. If the remaining power of the battery 208 is smaller than the threshold value (no), alarm notification is performed at step 1105 by displaying a display picture as shown in part (d) of FIG. 14 on the display 103 and the start of the automatic reproduction function is prohibited at step 1106. The by start of the automatic reproduction function is prohibited by refraining from activating a program for the automatic reproduction function. The device for performing the alarm notification is not limited to the display 103 and may be performed by at least one of the display 103, the receiver 102, and the alarm device 204. In the above process, the alarm notification is performed after the judgment at step 1103 before the prohibition of the start of the automatic reproduction function. Alternatively, the start of the automatic reproduction function may be prohibited without performing the alarm notification.

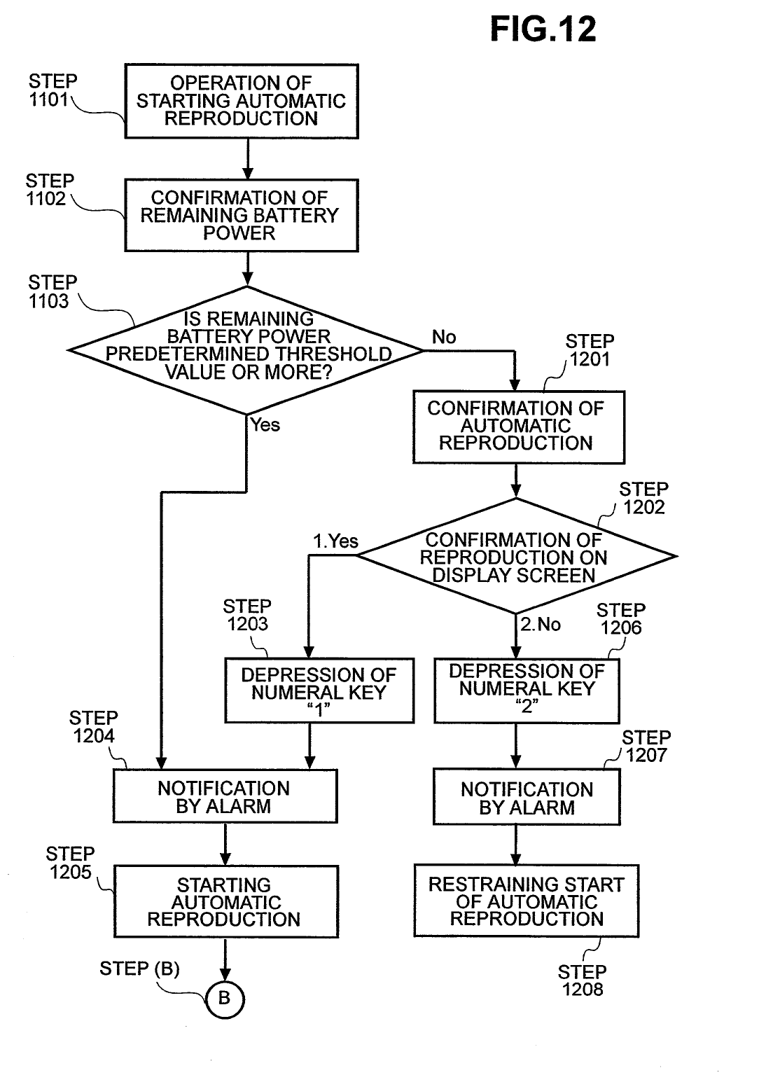

The portable mobile unit may be configured in such a manner that the start of reproduction of data (musical data) is permitted by a predetermined manipulation even if remaining power of the battery 208 is smaller than the threshold value when the user has made a manipulation for starting reproduction of the data. A process corresponding to this case will be described below with reference to FIGS. 12 and 14. This process makes it possible to start reproduction of data (musical data) upon a manipulation by the user in a case where the user allows the communication function to be disabled. FIG. 12 is a flowchart of this process and (a), (b), and (d) of FIG. 14 show display examples of alarm notification. Step 1101 (manipulations for starting automatic reproduction) to step 1103 (inquiry about remaining battery energy) are the same as the corresponding steps in FIG. 11 and hence will not be described. If it is judged at step 1103 that remaining power of the battery 208 is smaller than the threshold value (no), the process goes to step 1201 (start of confirmation of automatic reproduction). At step 1202, a picture for confirmation as shown in part (a) of FIG. 14 is displayed on the display 103. If the user depresses the numeral key “1” (yes) of the input keys 105 at step 1203, the process goes to step 1204, where a picture as shown in part (b) of FIG. 14 is displayed. Automatic reproduction is started at step 1205. On the other hand, the user depresses the numeral key “2” (no) of the input keys 105 at step 1206, the process goes to step 1207, where a picture as shown in part (d) of FIG. 14 is displayed. The start of the automatic reproduction function is prohibited at step 1208. If it is judged at step 1103 that the remaining power of the battery 208 is greater than or equal to the threshold value (yes), alarm notification is performed at step 1204 and automatic reproduction is started at step 1205. The device for performing the alarm notification is not limited to the display 103 and may be performed by at least one of the display 103, the receiver 102, and the alarm device 204.

In the above process, the alarm notification is performed at step 1207 that follows step 1206 and at step 1207 that follows step 1103 or 1203. Alternatively, the start of the automatic reproduction function may be prohibited and the automatic reproduction may be started without performing the alarm notification.

The above process enables the user to start reproduction of data (musical data) by performing a manipulation while a menu picture is displayed in a case where he allows the communication function to be disabled.

The portable mobile unit may be configured in such a manner that automatic reproduction is stopped after a lapse of an arbitrary preset time from its start. This makes it possible to prevent power consumption due to a failure of stopping automatic reproduction.

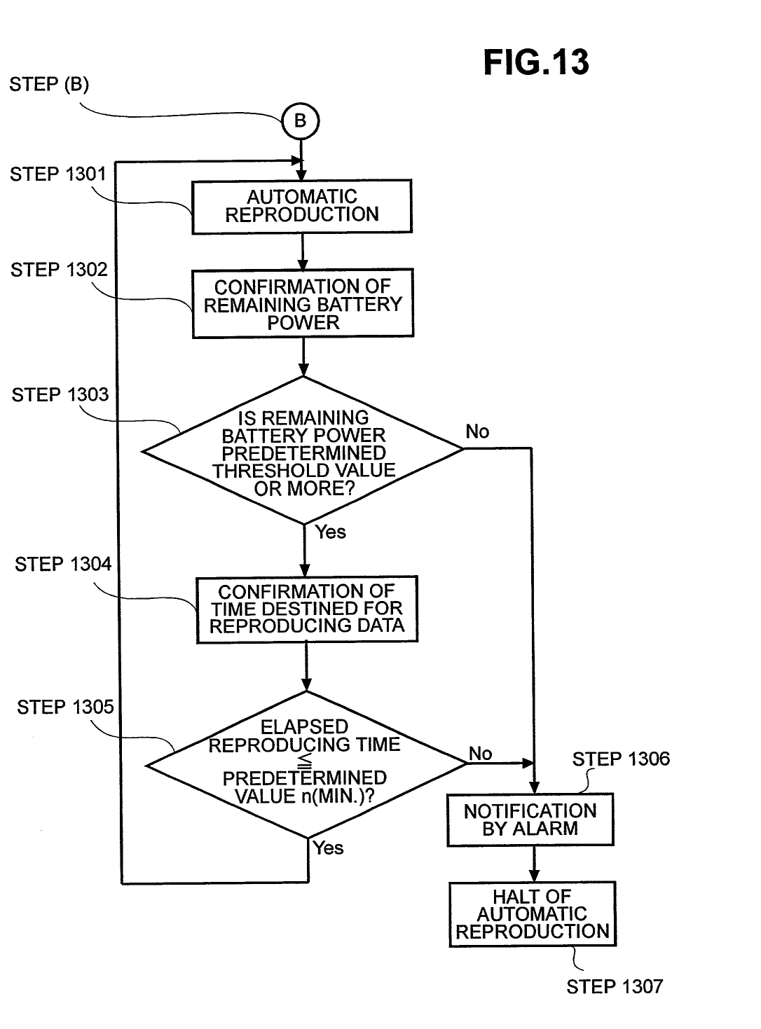

The portable mobile unit may be configured in such a manner that the reproduction time of data (musical data) is set at an arbitrary time. Automatic reproduction of data (musical data) is stopped after a lapse of a preset time from its start. FIG. 13 is a flowchart showing a process corresponding to this case. Part (c) of FIG. 14 shows a display example of alarm notification corresponding to this case. When automatic reproduction is started at step 1104 in FIG. 11 and step (B) is established, the automatic reproduction is continued at step 1301. The process goes to step 1302 (start of a check of remaining battery energy). Then, to check remaining power of the battery 208, at step 1303 the controller 203 inquires, of the remaining power detector 1001, remaining power of the battery 208 and judges whether the remaining power of the battery 208 is greater than or equal to a threshold value that is large enough to secure a predetermined speech time. If the remaining power of the battery 208 is greater than or equal to the threshold value (yes), the process goes to step 1304 (start of a check of a reproduction time). If it is judged at step 1303 that the remaining power of the battery 208 is smaller than the threshold value (no), alarm notification is performed at step 1306 by displaying a picture as shown in part (c) of FIG. 14 on the display 103 and the automatic reproduction is stopped at step 1307.

After step 1304 (start of a check of a reproduction time), at step 1305 the controller 203 judges whether the reproduction time has reached an arbitrary preset time (n minutes). Monitoring the reproduction time, the controller 203 compares the reproduction time with the arbitrary time (n minutes) that is preset in the memory 205. If the reproduction time has reached the arbitrary preset time (no), alarm notification is performed at step 1306 by displaying a picture as shown in FIG. 8A on the display 103 and the automatic reproduction is stopped at step 1307. On the other hand, if the reproduction time has not reached the arbitrary preset time yet (yes), the process returns to step 1301, where the automatic reproduction is continued. The device for performing the alarm notification is not limited to the display 103 and may be performed by at least one of the display 103, the receiver 102, and the alarm device 204.

With the above process, not only is the user allowed to enjoy music for a desired time but also useless power consumption due to a failure of stopping reproduction can be prevented because the reproduction is stopped after a lapse of the preset time.

In the above process, the alarm notification is performed after the judgment at step 1303 or 1305 before the stop of the automatic reproduction. Alternatively, the automatic reproduction may be stopped without performing the alarm notification.

The portable mobile unit may be configured in such a manner that the user can set the automatic reproduction time at an arbitrary time. A setting method is the same as described above with reference to FIGS. 7 and 9 (first embodiment); an automatic reproduction time is set according to display pictures on the display 103. This allows the user to enjoy music for a desired time.

The portable mobile unit may be configured in such a manner that the function of prohibiting the start of automatic reproduction if the remaining battery energy is smaller than the preset value is set or canceled selectively. This enables selection as to whether to activate this function.

Further, an alarm may be generated before stopping automatic reproduction. This allows the user to know in advance an approaching stop of reproduction of data (music).

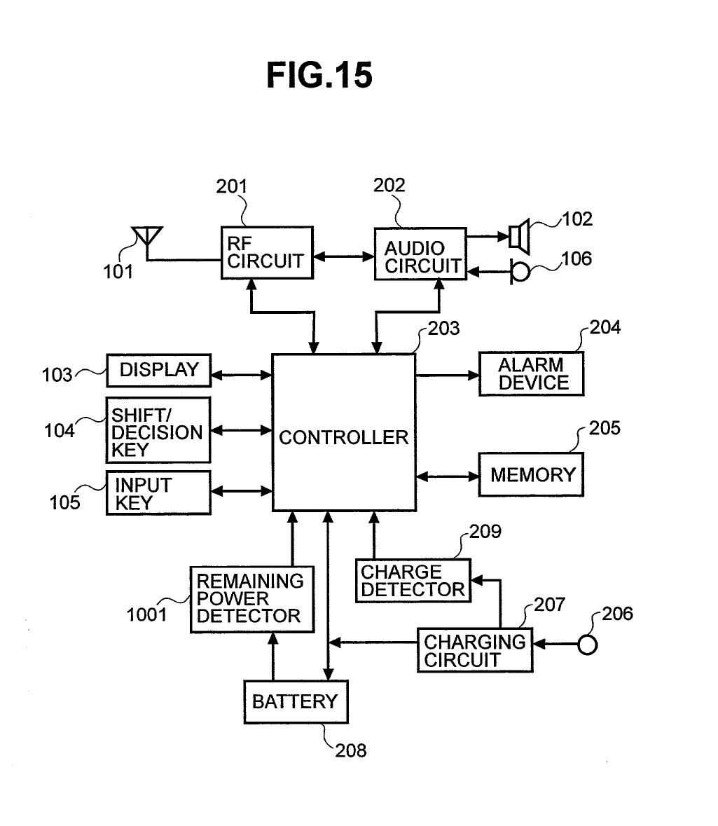

A portable mobile unit according to a third embodiment of the invention will be described below with reference to FIG. 15. This embodiment is such that two or more of the functions described above are incorporated in a single portable mobile unit. Specifically, in the portable mobile unit according to this embodiment, the functions of the first and second embodiments are incorporated in a single body in a manner shown in FIG. 15 so that the single portable mobile unit can perform a plurality of functions. The functions of the respective constituent blocks in FIG. 15 are the same as the functions of the corresponding blocks in FIG. 2 (first embodiment) and FIG. 10 (second embodiment) and hence will not be described. This embodiment makes it possible to improve ease of use by performing notification using favorite music of the user during charging as well as to increase the speech-possible time by prohibiting activation of the music reproduction function as a built-in function.

Each of the above embodiments is directed to the cellular phone as an exemplary portable mobile unit. However, the invention is not limited to the cellular phone and can be applied to general portable mobile units that has a built-in function that is different from the communication function. Although each of the above embodiments is directed to the case where the built-in function is the music reproduction function, the built-in function is not limited to the music reproduction function and may be any function other than the communication function. For example, the built-in function may be a game, a telephone directory, scheduling, mail writing, or the like. In these cases, the output means for reproducing data may include the display, an illumination device, etc. as well as the receiver and the alarm device. It goes without saying that the picture display method, the notification method, the manipulation method, and the processing method are not limited to those according to the above embodiments.

In the above embodiments, the start of the automatic reproduction function is prohibited by refraining from activating a program for the automatic reproduction function. However, the invention is not limited to such a case; the program may be stopped after being activated. Further, in the above embodiments, each of the charge detector and the remaining power detector is a separate constituent block. However, the invention is not limited to such a case; each of those detectors may be incorporated in another block or an equivalent function may be realized as software of the controller.

What is claimed is:

1. A portable mobile unit comprising:
a memory for storing data;
a controller for controlling reproduction of said stored data; and
a charge detector for detecting a charging state of a battery,
wherein said controller starts reproduction of said data when said charge detector detects that charging of said battery has started.

2. A portable mobile unit according to claim 1, wherein said controller performs control so as to stop said data reproduction after a lapse of an arbitrary preset time from the start thereof.

3. A portable mobile unit according to claim 1, wherein said controller performs control so as to stop said data reproduction when said charge detector detects suspension of said battery charging after the start of said data reproduction.

4. A portable mobile unit according to claim 2, wherein said charge detector is so configured as to be able to produce different outputs for a completion of said battery charging or an interruption by a user by recognizing whether a cause of suspension is said completion or said interruption.

5. A portable mobile unit according to claim 2, wherein said controller performs control so as to stop said data reproduction when said charge detector detects suspension of said charging of said battery after the start of said data reproduction.

6. A portable mobile unit according to claim 3, wherein said controller performs control so to make notification before stopping said data reproduction when said charge detector detects said suspension of said battery charging.

7. A portable mobile unit according to claim 3, wherein said charge detector is configured so as to be able to produce different outputs for a completion of said battery charging or an interruption by a user by recognizing whether a cause of suspension is said completion or said interruption.

8. A portable mobile unit according to claim 4, wherein the controller performs control so to make notification before stopping said data reproduction when said charge detector detects said suspension of said battery charging.

9. A portable mobile unit comprising:
a memory for storing data;
a controller for controlling reproduction of said stored data; and
a remaining power detector for detecting remaining power of a battery,
wherein said controller prohibits a start of reproduction of the data when said remaining power detector detects that remaining power of said battery is smaller than a preset value.

10. A portable mobile unit according to claim 9, wherein said controller performs control so as to stop said data reproduction after a lapse of an arbitrary preset time from a start of said data reproduction.

11. A portable mobile unit according to claim 9, wherein said controller cancels said prohibition of said data reproduction when a predetermined manipulation is made even if the remaining power of said battery is smaller than said preset value.

12. A portable mobile unit according to claim 10, wherein said controller performs control so as to generate an alarm is before stopping said data reproduction.

13. A portable mobile unit according to claim 11, wherein said controller performs control so as to stop said data reproduction after a lapse of an arbitrary preset time from the start thereof.

14. A portable mobile unit according to claim 13, wherein said controller performs control so as to generate an alarm is before stopping said data reproduction.
